(19) United States
(12) Patent Application Publication
(10) Pub. No.: US 2016/0244022 A1
(43) Pub. Date: Aug. 25, 2016

(54) VEHICLE CONTROL ACTION SEQUENCE FOR OPERATOR AUTHENTICATION

(71) Applicant: Ford Global Technologies, LLC, Dearborn, MI (US)

(72) Inventors: Mark Allan Lippman, New Baltimore, MI (US); Mangala A. Jayasuriya, Bloomfield Hills, MI (US); Allan Roy Gale, Livonia, MI (US)

(21) Appl. No.: 14/630,177

(22) Filed: Feb. 24, 2015

(51) Int. Cl. B60R 25/01; B60R 16/023

(52) U.S. Cl. CPC B60R 25/01; B60R 16/023

(57) ABSTRACT

When a vehicle is not in a motive mode, a controller may monitor operator input entered via vehicle controls that have functions other than access control, and enable the vehicle to transition to the motive mode if the operator input matches a predetermined vehicle-enable action sequence. The controller may also, responsive to operator input requesting to record the vehicle-enable action sequence, construct a vehicle-enable action sequence according to subsequent operator input entered by the operator via the vehicle controls; and apply the vehicle-enable action sequence as a requirement to be repeated by a vehicle operator to enable transition to motive mode.

### TECHNICAL FIELD

Aspects of this disclosure relate to using sequences of vehicle control actions for authenticating vehicle operators.

### BACKGROUND

Vehicle systems today may be equipped with key fob authentication that allows for keyless entry and push button starting. As inclusion of such systems into vehicles becomes more commonplace, ways to defeat key fob authentication technology continue to evolve. In an example, some push button start vehicles may be stolen by programming a key fob with information retrieved from a device connected to the vehicle on-board diagnostic (ODB) port, and then using the newly programmed key fob to start the vehicle.

Other issues exist with push button start systems. For example, a push button start system may be designed to allow a vehicle to continue to run once started, even after the key fob is no longer within range of the vehicle. However, this may lead to situations where a person having the key fob may exit the vehicle, preventing the vehicle operator from restarting the vehicle after driving away and shutting the vehicle off.

### SUMMARY

In a first illustrative embodiment, a vehicle system includes a controller, in communication with a plurality of vehicle systems over at least one vehicle bus, configured to when the vehicle is not in a motive mode, monitor operator input entered via vehicle controls that have functions other than access control, and enable the vehicle to transition to the motive mode if the operator input matches a predetermined vehicle-enable action sequence.

In a second illustrative embodiment, a vehicle system includes a controller, in communication with a plurality of vehicle systems over at least one vehicle bus, configured to monitor operator input entered via vehicle controls that have functions other than access control, construct a vehicle-enable action sequence according to the operator input, and apply the vehicle-enable action sequence as a requirement to be repeated by a vehicle operator to enable transition to motive mode.

In a third illustrative embodiment, a computer-implemented method includes when a vehicle is not in a motive mode, monitoring, over a vehicle bus by a controller of the vehicle in communication with a plurality of vehicle systems over the vehicle bus, operator input entered via vehicle controls that have functions other than access control; and enabling the vehicle to transition to the motive mode if the operator input matches a predetermined vehicle-enable action sequence.

### BRIEF DESCRIPTION OF THE DRAWINGS

FIG. 1 illustrates an example system including a vehicle implementing vehicle-enable action sequences to enable entry into a running or motive vehicle state;

FIG. 2 illustrates an example portion of a vehicle including a plurality of controls that may be used for vehicle-enable action sequences;

FIGS. 3A and 3B illustrate an example user interface for configuration of vehicle-enable action sequences;

FIG. 4 illustrates an example process for recording vehicle-enable action sequences 120; and

FIG. 5 illustrates an example process for detecting vehicle-enable action sequences 120 to authorize transition into motive mode.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

A programmable access control system for a vehicle may be configured to add a level of security to keyless vehicle entry. The system may be configured to allow a vehicle operator to program a user action or set of user actions that must be executed before the vehicle will enter a running (motive) state. The system may be utilized on both keyed and keyless vehicle ignition systems.

In an example, the vehicle operator may utilize the vehicle human-machine interface (HMI) to enter a security menu of the vehicle. From the menu, the vehicle operator may select to program a vehicle-enable action sequence. The vehicle-enable action sequence may describe a combination of control presses that must be performed to enable the vehicle to enter the running state. Once in the programming mode, the operator may utilize vehicle controls that have functions other than access control to input a sequence of arbitrary vehicle control actions. For instance, after selecting to program the vehicle-enable action sequence, the operator may depress the brake pedal two times, and/or may press a control button on the steering wheel. Or, the operator may hold one or more controls down for an amount of time, e.g., three seconds, five seconds. When the programming is complete, the operator may select to save the sequence. Once saved, the sequence may be modified by returning to the security menu and selecting to program a new vehicle-enable action sequence.

The system may then require the saved sequence to be reentered using the vehicle controls before enabling the vehicle to enter the running state. To continue with the above sequence examples, the vehicle operator may enter the vehicle, perform the sequence (e.g., depressing the brake pedal two times, hold one or more controls down for the recorded amount of time), and then press the start button to enter motive mode. Or, for a keyed access vehicle, the vehicle operator may turn the key to start or to accessory, and may perform the sequence to enable the start functionality, and then may complete the start sequence.

In many examples, the vehicle-enable action sequence maybe utilized in addition to the key or key fob as a second security measure required before allowing the vehicle to enter motive mode. In other examples, the system may be configured to allow for the operator of the vehicle to enter the vehicle-enable action sequence to start the vehicle, without requiring the key or key fob.

In some cases, further secondary security measures may also be utilized by the vehicle using other vehicle sensors. For instance, radar, lidar, or stereo camera systems such as those used in autonomous vehicles may be further used to recognize individuals, as a further confirmation that an authorized user is attempting to use the vehicle.

While many of the examples discussed herein relate to the in-vehicle context, it should be noted that the vehicle-enable action sequence techniques may be applicable to other environments in which access is restricted and having controls that have functions other than access control that may be used for input and identity verification, such as homes, offices, or other structures. Further aspects of the system are described in detail with respect to the Figures below.

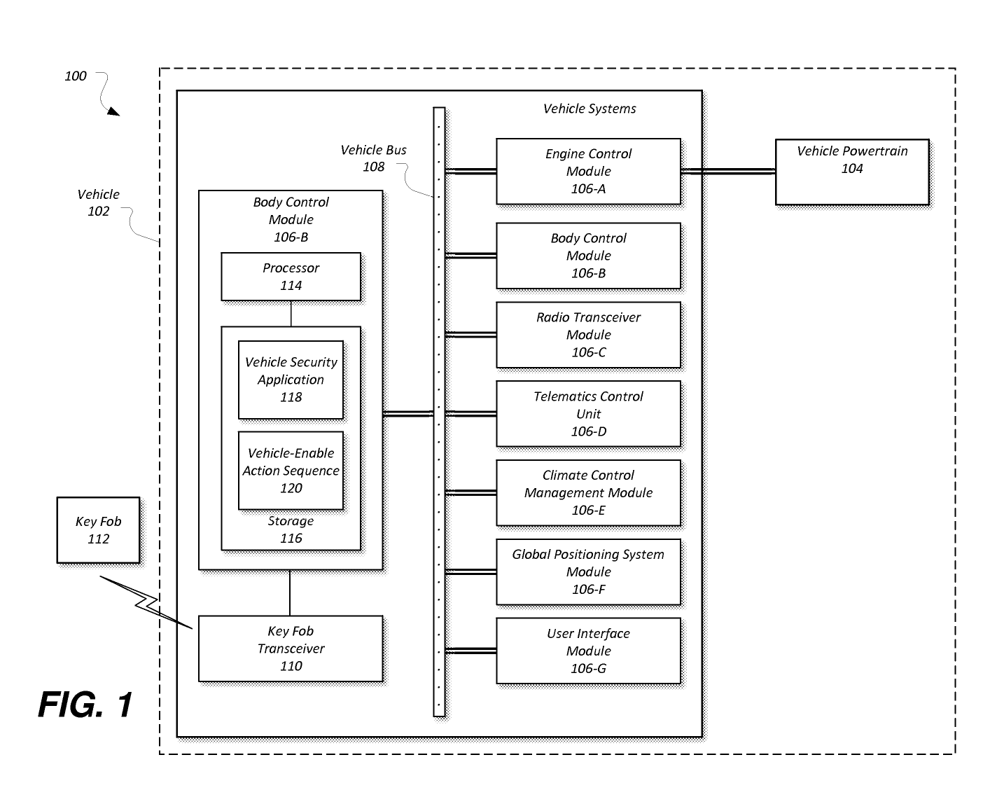

FIG. 1 illustrates an example system 100 including a vehicle 102 implementing vehicle-enable action sequences 120 to enable entry into a running or motive vehicle state. As illustrated, the vehicle 102 includes a vehicle powertrain 104 connected to one or more vehicle wheels to propel the vehicle, and a plurality of vehicle modules 106 in communication over one or more vehicle buses 108 to control the vehicle powertrain 104 and other vehicle 102 functions. The vehicle 102 further includes a key fob transceiver 110 configured to communicate with a key fob 112, and a vehicle security application 118 installed to the body control module 106-B. As explained in greater detail below, the body control module 106-B utilizes the vehicle security application 118 to enable placement of the vehicle 102 into motive mode according to vehicle-enable action sequences 120.

The vehicle 102 may be one of various types of passenger vehicles, such as a crossover utility vehicle (CUV), a sport utility vehicle (SUV), a truck, a recreational vehicle (RV), a boat, a plane or other mobile machine for transporting people or goods. The vehicle powertrain 104 may include one or more engines or motors configured to supply the motive force to propel the vehicle 102. In an example, the vehicle 102 may be powered by an internal-combustion engine coupled to the drive wheels via a transmission to a differential. In another example, the vehicle 102 may be a micro-hybrid vehicle 102 propelled by the engine having an enhanced starter motor, such that the starter motor is used to start the engine when torque is required and the engine stopped when torque is not required to conserve fuel. In yet a further example, the vehicle 102 may be a hybrid vehicle 102 powered by an engine and one or more electric motors, or an electric vehicle powered by one or more electric motors without a gasoline engine.

For non-hybrid vehicle 102 that are powered by an internal-combustion engine, the engine may always be on when the vehicle is in a started or motive mode. For hybrid or pure electric vehicles 102, the vehicle 102 may be in a motive mode when the vehicle powertrain 104 is enabled to motivate the vehicle 102, whether or not the engine or other drivetrain components of the powertrain 104 are moving.

The plurality of vehicle modules 106 may be configured to control the vehicle powertrain 104 and other vehicle 102 functions. As depicted, the example vehicle modules 106 are represented as discrete modules 106-A through 106-G. However, the vehicle modules 106 may share physical hardware, firmware, and/or software, such that the functionality from multiple modules 106 may be integrated into a single module 106, and that the functionality of various such modules 106 may be distributed across a plurality of modules 106. The vehicle bus 108 may include various method of communication available between the system modules 106. As some non-limiting examples, the vehicle bus 108 may include a controller area network (CAN) bus and/or an Ethernet network.

The engine control module 106-A may be configured to provide control of vehicle drivetrain 104 operating components (e.g., idle control components, fuel delivery components, emissions control components, etc.) and for monitoring status of such engine operating components (e.g., status of engine fault codes). The engine control module 106-A may further be responsive for managing the motive or non-motive status of the vehicle drivetrain 104.

The body control module 106-B may be configured to manage various power control functions, such as exterior lighting, interior lighting, and point of access status verification. The point of access status verification may include, as some possibilities, identification of open or closed status of the hood, doors and/or trunk of the vehicle 102.

The body control module 106-B may be further configured to manage keyless entry and start features of the vehicle 102 by way of a key fob transceiver 110 configured to send and receive messages between a key fob 112 and the vehicle 102. In a passive keyless entry/passive start (PEPS) system, an operator may carry an electronic transmission device, such as the key fob 112, to allow for “keyless” entry to the vehicle 102. To initiate a door unlock sequence, the operator may touch or move in close proximity to a PEPS handle capacitive sensor of a vehicle 102 door handle.

Upon an identification of the potential presence of an owner by a capacitive sensor, the body control module 106-B may request for the key fob transceiver 110 to initiate a challenge-accept sequence with the key fob 112. The sequence may include the key fob transceiver 110 sending a low-frequency key wake-up message to the key fob 112, and listening for a high-frequency response from the key fob 112 including an identification code. Upon receipt of the correct identification code, the key fob transceiver 110 may inform the body control module 106-B of presence of a key fob 112 authorized for the vehicle 102, and the body control module 106-B may accordingly unlock the vehicle 102 doors.

Once inside the vehicle 102, the operator may request for the vehicle 102 to enter motive mode, such as by inserting a key into a vehicle lock and turning the key to a start position, or by pressing a start button of the vehicle 102. If the operator is authenticated to use the vehicle 102, the body control module 106-B may indicate to the engine control module 106-A to transition the vehicle 102 into motive mode.

The vehicle 102 may include additional modules 106, such as a telematics control unit 106-D configured to send and receive commands from the paired communications device and/or via an in-vehicle modem connection to a communications network; a climate control management module 106-E configured to provide control of heating and cooling system components (e.g., compressor clutch, blower fan, temperature sensors, etc.); a global positioning system (GPS) module 106-F configured to provide vehicle location information; and a user interface module 106-G configured to provide vehicle status information to a driver, such as fuel level info, engine operating temperature information, and current location of the vehicle 102.

The body control module 106-B may include various types of computing apparatus to facilitate the performance of the functions of the body control module 106-B. In an example, the body control module 106-B may include a processor 114 configured to execute computer instructions, and a storage medium 116 on which the computer-executable instructions may be maintained. A computer-readable storage medium 116 (also referred to as a processor-readable medium 116 or storage 116) includes any non-transitory (e.g., tangible) medium that participates in providing data (e.g., instructions) that may be read by a computer (e.g., by the processor 114). In general, a processor 114 receives instructions, e.g., from the storage 116, etc., and executes these instructions, thereby performing one or more processes, including one or more of the processes described herein. Computer-executable instructions may be compiled or interpreted from computer programs created using a variety of programming languages and/or technologies, including, without limitation, and either alone or in combination, Java, C, C++, C#, Fortran, Pascal, Visual Basic, Java Script, Perl, PL/SQL, etc.

The vehicle security application 118 may be one such application installed to the storage medium 116 of the body control module 106-B. (In other examples, the vehicle security application 118 application or functionality may be implemented in whole or in part by other modules 106 of the vehicles 102, such as by a separate security module, by the engine control module 106-A, as an application installed to the telematics control unit 106-D, etc.) When executed by the processor 114, the vehicle security application 118 may be configured to cause the body control module 106-B to monitor vehicle bus 108 activity and/or other inputs to the vehicle 102 to record and detect vehicle-enable action sequences 120. The vehicle-enable action sequence 120 may include a sequence of control inputs to the vehicle 102 that must be performed to enable the vehicle to enter the running state. The control inputs may be of vehicle controls that have functions other than access control to the vehicle 102. The control inputs recognized for the vehicle-enable action sequence 120 may include one or more of: individual control actions, combinations of substantially simultaneous control actions (e.g., pressing multiple controls at once), as well as timing information (e.g., for how long the controls were pressed, and/or timing between control presses). When the correct vehicle-enable action sequence 120 is verified, the vehicle security application 118 may further include instructions configured to cause the body control module 106-B to issue one or more commands to the vehicle modules 106 (e.g., to the engine control module 106-A) to enable start functionality of the vehicle 102.

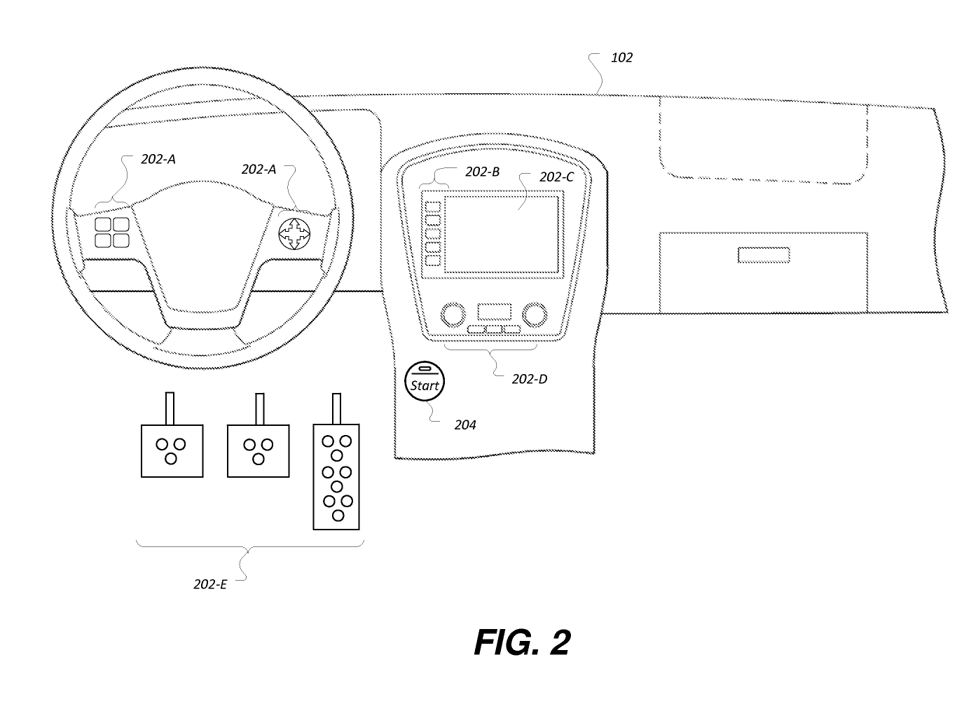

FIG. 2 illustrates an example portion of a vehicle 102 including a plurality of vehicle controls 202 that may be used for entering vehicle-enable action sequences 120, and a start control 204 that may be used by the vehicle operator to transition the vehicle 102 into and out of motive mode. The vehicles operator may accordingly use the vehicle controls 202 to enter vehicle-enable action sequences 120, and the start control 204 to enable the vehicles 102 to start when a proper vehicle-enable action sequence 120 has been entered.

The vehicle controls 202 include interface elements configured to provide control input to the vehicle 102 that is accessible to the vehicles security application 118. In an example, the vehicle controls 202 may include various controls of the vehicles 102 that are configured to provide information regarding their state over one or more vehicles buses 108. The body control module 106-B may accordingly receive the control state information and provide it to the vehicle security application 118. In another example, the vehicles controls 202 may be configured to provide information regarding their state to the vehicles security application 118 via other mechanisms, such as an alternate vehicles 102 network, direct connection to the vehicle controls 202, or via another network or connection to one or more vehicle modules 106 configured to provide vehicle control 202 state information.

As some examples of vehicle controls 202, the vehicle controls 202 may include steering wheel buttons 202-A, hard controls 202-B of the human machine interface (HMI) of the user interface module 106-G, a touch screen 202-C of the HMI of the user interface module 106-G, HVAC controls 202-D for control of the climate control management module 106-E, and input to vehicle pedals 202-E (e.g., accelerator pedal input, brake pedal input, clutch pedal input, as some possibilities). Notably, as the vehicle controls 202 include one or more controls that have functions other than access control, the vehicle-enable action sequences 120 may be performed using existing controls of the vehicle 102, without requiring additional vehicle 102 control elements.

The start control 204 may include various types of controls that may be used to signal to the vehicle 102 to transition into and out of the motive mode (e.g., start and stop the vehicle 102). In an example, for a vehicle 102 implementing keyless entry and start, the start control 204 may be a pushbutton control. In another example, for a keyed vehicle 102, the start control 204 may be a keyed ignition switch having positions for the vehicle 102 to be started and to be turned off (not shown).

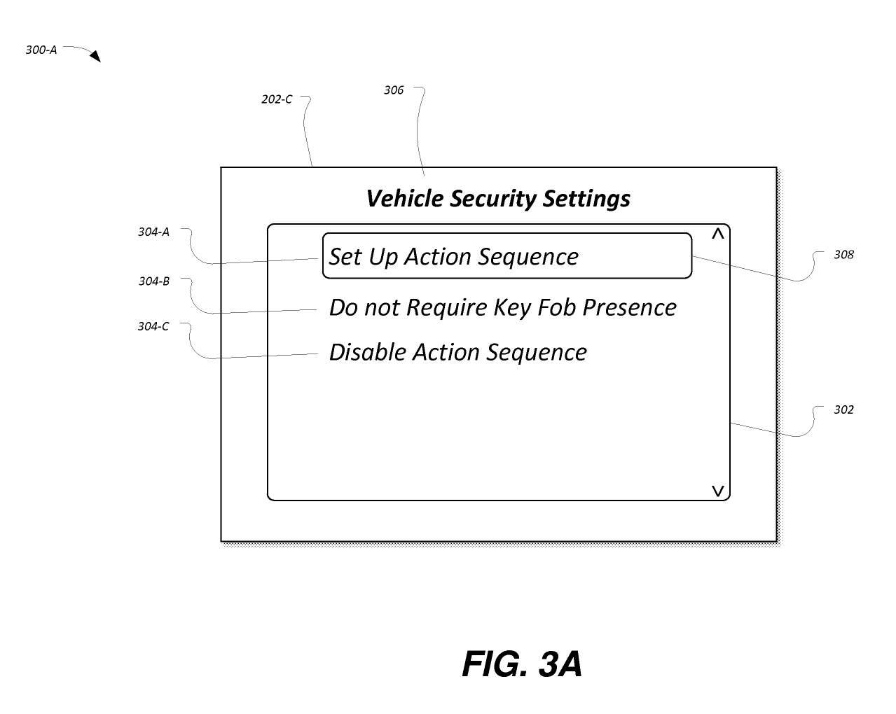

FIGS. 3A and 3B illustrate an example user interface 300 for configuration of vehicle-enable action sequences 120. In an example, the user interface 300 may be presented in the vehicle 102 via the touch screen 202-C of the HMI of the user interface module 106-G responsive to operator selection to configure vehicle security settings. In some cases, if the vehicle 102 is not in motive mode, the vehicle 102 may require the user to authenticate in accordance with the current vehicle-enable action sequence 120 and other authentication requirements (e.g., presence of key fob 112 if applicable) before allowing access to the user interface 300. The vehicle 102 may also prevent access to the vehicle security settings if the vehicle 102 is in valet mode.

The user interface 300 may include a list control 302 configured to display selectable list entries 304-A through 304-C (collectively 304) regarding actions that are available to configure security settings for the vehicle 102. As illustrated, the selectable list entries 304 include an entry 304-A for setting up a vehicle-enable action sequences 120, an entry 304-B for allowing the operator to enable or disable requiring presence of the key fob 112 to start the vehicle 102 and an entry 304-C for allowing the operator to enable or disable the requirement for an operator to enter a vehicle-enable action sequence 120. The list control 302 may operate as a menu, such that a user of the user interface 300 may be able to scroll through list entries of the list control 302 (e.g., using voice commands, or up and down arrow buttons and a select button to invoke the selected entry 304). The user interface 300 may also include a title label 306 to indicate to the user that the user interface 300 is for configuration of the vehicle security settings.

In an example, responsive to selection of the entry 304-A for setting up a vehicle-enable action sequences 120 (e.g., via touch or the select button), the vehicle 102 may allow the operator to enter in a new vehicle-enable action sequence 120. For example, as illustrated in FIG. 3B, when allowing the user to enter the vehicle-enable action sequence 120, the user interface 300 may be updated to display an information label 310 including information describing the vehicle-enable action sequences 120, as well as controls 312 to be used to control entering the vehicle-enable action sequence 120. For example, an apply control 312-A, when invoked, may be configured to cause the vehicle 102 to apply the vehicle-enable action sequences 120 for use and return to the menu displayed in FIG. 3A, a cancel control 312-B, when invoked, may be configured to cause the vehicle 102 to discard any entered vehicle-enable action sequences 120 and return to the menu displayed in FIG. 3A, a retry control 312-C, when invoked, may be configured to cause the vehicle 102 to discard any entered vehicle-enable action sequences 120 but allow the user to enter a new vehicle-enable action sequence 120, and a help control 312-D, when invoked, may be configured to cause the vehicle 102 to display or provide a voice prompt including further information regarding setup of the vehicle-enable action sequence 120.

Returning to FIG. 3A, the “Do not Require Key Fob Presence” entry 304-B, when invoked, may be configured to cause the vehicle 102 to toggle whether the key fob 112 is required to enable the vehicle 102. For instance, in some cases the operator may wish to allow the vehicle 102 to be started without also requiring presence of the key fob 112. In such a case, the operator may be able to unlock the vehicle 102 by entering a code on a keyless entry keypad (e.g., on the B-pillar of the vehicle 102) and start the vehicle 102 by entering the vehicle-enable action sequence 120, all without needing the key fob 112. In other cases, the operator may desire to require the key fob 112 to be present to start the vehicle 102, in order to provide a second level of security to the vehicle 102. In some examples, if the operator elects to disable requiring presence of the key fob 112, the text of the entry 304-B may update to read “Require Key Fob Presence” to indicate to the operator that requiring the key fob 112 is currently disabled and would require selection of the entry 304-B to re-enable the requirement for key fob 112 presence before allowing the vehicle 102 to be started.

The “Disable Action Sequence” entry 304-C, when invoked, may be configured to cause the vehicle 102 to toggle whether the vehicle-enable action sequence 120 is required to enable the vehicle 102. For instance, in some cases the operator may wish to allow the vehicle 102 to be started with the key fob 112, without requiring the user to enter the vehicle-enable action sequence 120. In some examples, if the operator elects to disable requiring the operator to enter the vehicle-enable action sequence 120, the text of the entry 304-C may update to read “Enable Action Sequence” to indicate to the operator that requiring entry of the vehicle-enable action sequence 120 is currently disabled and would require selection of the entry 304-C to re-enable the requirement for entry of the vehicle-enable action sequence 120 before allowing the vehicle 102 to be started.

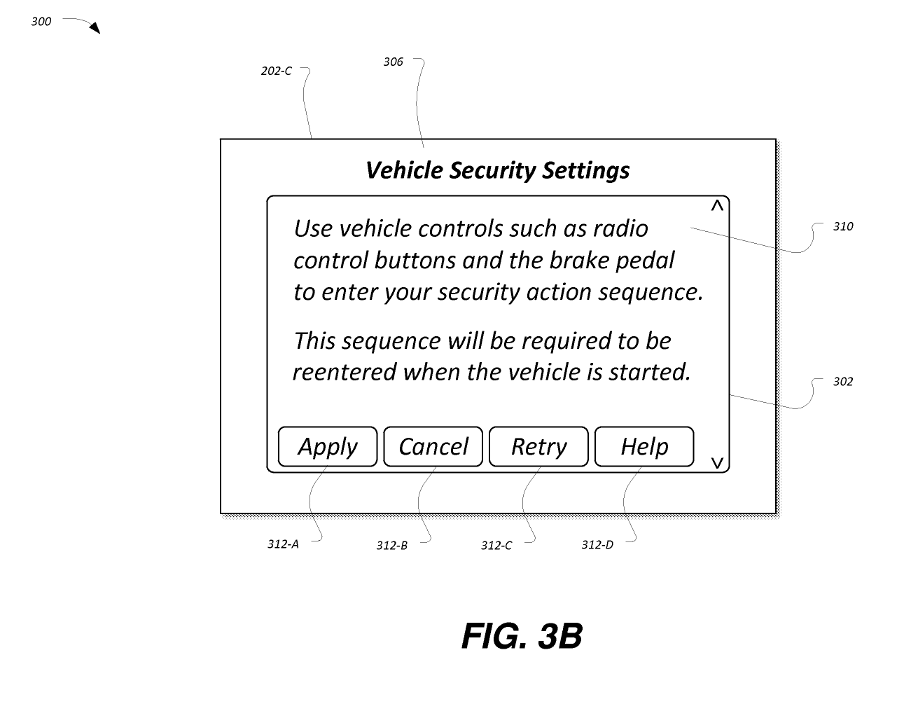

FIG. 4 illustrates an example process 400 for recording vehicle-enable action sequences 120. The process 400 may be performed, in an example, at least in part by the body control module 106-B of the vehicle 102.

At operation 402, the vehicle 102 receives a request to record a vehicle-enable action sequence 120. In an example, the user may select the entry 304-A for setting up a vehicle-enable action sequences 120 from the list control 302 of the user interface 300.

At operation 404, the vehicle 102 monitors vehicle bus 108 traffic to log actions for use in the vehicle-enable action sequence 120. In an example, the vehicle security application 118 may be configured to cause the body control module 106-B to monitor vehicle bus 108 activity and/or other inputs to the vehicle 102 to detect control inputs to the vehicle 102 to be performed to enable the vehicle to enter the running state.

At operation 406, the vehicle 102 constructs the vehicle-enable action sequence 120 from the monitored vehicle bus 108 traffic. In an example, based on the received vehicle bus 108 activity, the vehicle security application 118 may identify and store a vehicle-enable action sequence 120 indicative of the monitored control inputs to the vehicle 102.

At operation 408, the vehicle 102 saves the vehicle-enable action sequence 120 for use in authorizing the transition of the vehicle 102 into motive mode. In an example, the vehicle-enable action sequence 120 may be stored to the body control module 106-B for later comparison to entered vehicle-enable action sequences 120. After operation 408, the process 400 ends.

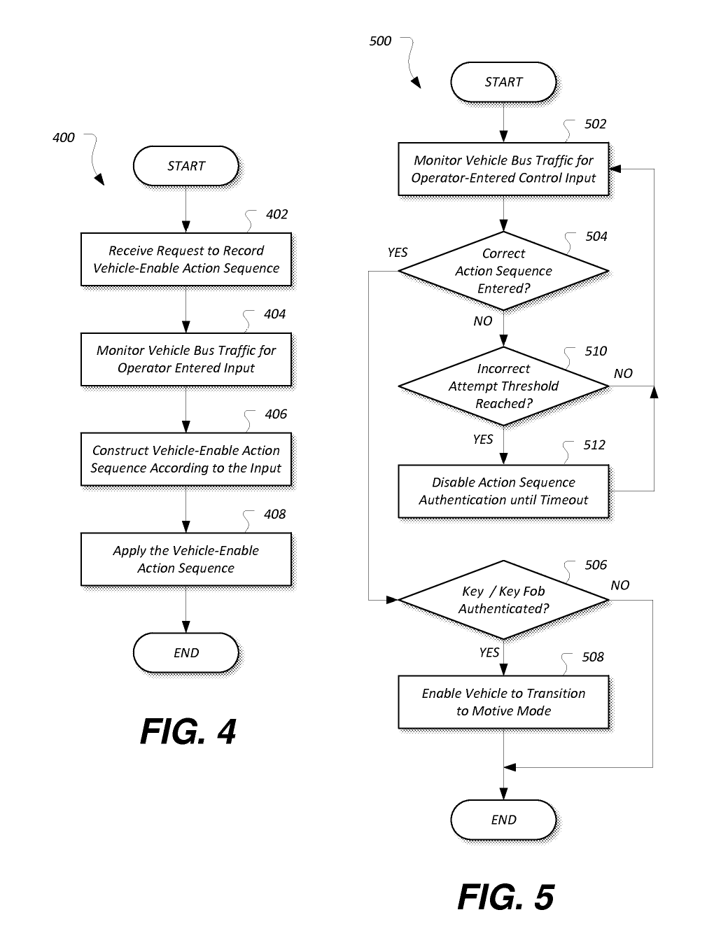

FIG. 5 illustrates an example process 500 for detecting vehicle-enable action sequences 120 to authorize transition into motive mode. As with the process 400, the process 500 may be performed, in an example, at least in part by the body control module 106-B of the vehicle 102.

At operation 502, the vehicle 102 monitors vehicle bus 108 traffic for operator-entered control input. In an example, the vehicle security application 118 may be configured to cause the body control module 106-B to monitor vehicle bus 108 activity and/or other inputs to the vehicle 102 to detect control inputs to the vehicle 102 to be performed to enable the vehicle to enter the running state. The detection may be initiated, for example, responsive to detection of a user unlocking the vehicle 102 using the keyless entry keypad, key, or key fob.

At operation 504, the vehicle 102 determines whether a correct vehicle-enable action sequence 120 was entered. In an example, based on the received vehicle bus 108 activity, the vehicle security application 118 may identify whether the received input matches to the vehicle-enable action sequence 120 stored to the body control module 106-B. If the correct vehicle-enable action sequence 120 is detected, control passes to operation 506. Otherwise, the vehicle 102 remains disabled and control passes to operation 510.

At operation 506, the vehicle 102 determines whether an authorized key or key fob 112 is present. In an example, if the settings of the body control module 106-B require that the key fob 112 be present (or the key be authenticated) to start the vehicle 102, the body control module 106-B may further confirm the presence of the key fob 112 or correct key in the ignition. If the settings do not require the key fob 112 or key, or if the correct key fob 112 or key is present, control passes to operation 508. Otherwise, the process 500 ends.

At operation 508, the vehicle 102 enables the transition to motive mode. Accordingly, the vehicle 102 may be started and available for use. After operation 508, the process 500 ends.

At operation 510, responsive to receipt of an incorrect vehicle-enable action sequence 120, the vehicle 102 determines whether an incorrect attempt threshold was reached. For example, the vehicle 102 may be configured to accept up to a predetermined number of incorrect vehicle-enable action sequences 120 (e.g., three, five, ten, etc.) without an intervening interval of time (e.g., five minutes, ten minutes, fifteen minutes, etc.) before locking out access to attempt further vehicle-enable action sequences 120. If the predetermined number of incorrect vehicle-enable action sequences 120 is reached within the interval of time without receipt of a correct vehicle-enable action sequence 120, control passes to operation 512. Otherwise control returns to operation 502.

At operation 512, the vehicle 102 disables use of the vehicle-enable action sequences 120. In an example, the vehicle 102 may disable use of the vehicle-enable action sequences 120 to enable the vehicle 102 to transition to motive mode. To re-enable vehicle-enable action sequences 120, the vehicle 102 may require additional authentication, e.g., authentication via presence of the key fob 112, authentication via presence of two vehicle 102 key fobs, or may require a timeout to expire (e.g., five minutes, ten minutes, fifteen minutes, etc.) before vehicle-enable action sequences 120 may again be processed. After operation 512, control returns to operation 502.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A vehicle system comprising:
a controller, in communication with a plurality of vehicle systems over at least one vehicle bus, configured to
when the vehicle is not in a motive mode, monitor operator input entered via vehicle controls that have functions other than access control, and
enable the vehicle to transition to the motive mode if the operator input matches a predetermined vehicle-enable action sequence.

2. The system of claim 1, wherein the vehicle-enable action sequence includes one or more of: (i) individual vehicle control actions, (ii) combinations of substantially simultaneous vehicle control actions, (iii) timing information indicative of for how much time the vehicle control actions occur, and (iv) timing information indicative of how long between the vehicle control actions.

3. The system of claim 1, wherein the controller is further configured to indicate in a human-machine interface of the vehicle when the operator input matches the predetermined vehicle-enable action sequence.

4. The system of claim 1, wherein the controller is further configured to monitor operator input via monitoring the vehicle bus.

5. The system of claim 1, further comprising a key fob transceiver, in communication with the controller, configured to monitor for presence of an operator key fob, wherein the controller is further configured to additionally require presence of the operator key fob in addition to entrance of the vehicle-enable action sequence to enable the vehicle to transition to motive mode.

6. The system of claim 1, wherein the vehicle controls include at least one of: (i) steering wheel controls, (ii) vehicle pedals, and (iii) climate controls.

7. The system of claim 1, wherein the controller is further configured to begin to monitor the operator input responsive to operator input to transition to the motive mode.

8. The system of claim 7, wherein the operator input to transition to the motive mode includes one of: (i) input responsive to a turn of a key in an ignition switch of the vehicle, and (ii) input responsive to a press of a start button of the vehicle.

9. The system of claim 1, wherein the controller is further configured to enable the vehicle to transition to the motive mode before receiving operator input to transition to the motive mode.

10. The system of claim 1, wherein the controller is a body control module of the vehicle.

11. A vehicle system comprising:
a controller, in communication with a plurality of vehicle systems over at least one vehicle bus, configured to
monitor operator input entered via vehicle controls that have functions other than access control,
construct a vehicle-enable action sequence according to the operator input, and
apply the vehicle-enable action sequence as a requirement to be repeated by a vehicle operator to enable transition to motive mode.

12. The system of claim 11, wherein the controller is further configured to begin to monitor the operator input responsive to operator input requesting to record the vehicle-enable action sequence.

13. The system of claim 11, wherein the vehicle controls include at least one of:
(i) steering wheel controls, (ii) vehicle pedals, and (iii) climate controls.

14. The system of claim 11, wherein the controller is further configured to:
when the vehicle is not in the motive mode, monitor operator input entered via the vehicle controls that have functions other than access control, and
enable the vehicle to transition to the motive mode if the operator input matches the vehicle-enable action sequence.

15. The system of claim 11, wherein the controller is configured to identify, responsive to operator input, whether to additionally require presence of an operator key fob in addition to entrance of the vehicle-enable action sequence to enable the vehicle to transition to motive mode.

16. A computer-implemented method comprising:
when a vehicle is not in a motive mode, monitoring, over a vehicle bus by a controller of the vehicle in communication with a plurality of vehicle systems over the vehicle bus, operator input entered via vehicle controls that have functions other than access control; and
enabling the vehicle to transition to the motive mode if the operator input matches a predetermined vehicle-enable action sequence.

17. The method of claim 16, further comprising indicating in a human-machine interface of the vehicle when the operator input matches the predetermined vehicle-enable action sequence.

18. The method of claim 16, further comprising:
responsive to operator input requesting to record the vehicle-enable action sequence, constructing a vehicle-enable action sequence according to subsequent operator input entered by the operator via the vehicle controls; and
applying the vehicle-enable action sequence as a requirement to be repeated by a vehicle operator to enable transition to the motive mode.

19. The method of claim 16, wherein the vehicle controls include at least one of:
(i) steering wheel controls, (ii) vehicle pedals, and (iii) climate controls.

20. The method of claim 16, further comprising confirming presence of an operator key fob in addition to entrance of the vehicle-enable action sequence when enabling the vehicle to transition to motive mode.
